(19) United States
(12) Patent Application Publication
(10) Pub. No.: US 2025/0343251 A1
(43) Pub. Date: Nov. 6, 2025

(54) SEPARATOR PLATE FOR AN ELECTROCHEMICAL SYSTEM

(71) Applicant: Reinz-Dichtungs-GmbH, Neu-Ulm (DE)

(72) Inventors: Jonas LEISCHER, Neu-Ulm (DE); Andreas MICHALKE, Ulm (DE); Franz SCHWEIGGART, Pfaffenhofen (DE); Christoph SPECHT, Neu-Ulm (DE); Tobias TAUSCHER, Ulm (DE); Alexander TRIPPEL, Ulm (DE); Hans WALDVOGEL, Krumbach (DE)

(21) Appl. No.: 19/197,506

(22) Filed: May 2, 2025

(30) Foreign Application Priority Data
May 3, 2024 (DE) 20 2024 102 295.2

(51) Int. Cl. H01M 8/0263; H01M 8/0265

(52) U.S. Cl. CPC H01M 8/0263; H01M 8/0265

(57) ABSTRACT

The disclosure relates to a separator plate for an electrochemical system, comprising a first layer having a first outer side and a first inner side, and a second layer having a second outer side and a second inner side. A first channel-web structure having a plurality of channels and webs separating the channels is formed on the first outer side. The first channel-web structure forms a complementarily-shaped second channel-web structure on the first inner side. The second inner side faces the complementarily-shaped second channel-web structure and defines therewith a plurality of internal channels. A plurality of openings per internal channel each define a fluid connection between a respective internal channel and the first channel-web structure on the first outer side. The number of openings within a first half of a total channel length of a respective internal channel is less than within a second half of the total channel length.

### CROSS REFERENCE TO RELATED APPLICATION

This application claims priority to German Utility Model Application No. 20 2024 102 295.2, entitled “SEPARATOR PLATE FOR AN ELECTROCHEMICAL SYSTEM”, filed May 3, 2024. The entire contents of the above-identified application is hereby incorporated by reference for all purposes.

### TECHNICAL FIELD

The present disclosure relates to a separator plate for an electrochemical system, in particular for an electrolyzer.

### BACKGROUND AND SUMMARY

Electrolyzers usually comprise a stack of individual electrochemical cells, each of which has a plurality of layers, including at least one separator plate and a membrane electrode assembly (MEA), each individual cell being bounded by two adjacent separator plates. The stack of individual electrochemical cells can have two end plates that press the individual electrochemical cells together and give the stack stability. Furthermore, the individual electrochemical cells can comprise gas diffusion layers (GDL) and/or porous transport layers (PTL), which are arranged between the separator plate and the membrane electrode arrangement. The separator plate can fulfill several functions: indirect electrical contacting of electrodes of the membrane electrode assembly (MEA), separation of media such as water, oxygen or hydrogen and electrical connection of the neighboring individual electrochemical cells. The separator plate itself and each layer of a separator plate therefore usually separate the media. The separator plate is often also referred to as a bipolar plate.

The separator plate comprises at least one through-opening (port) as an inlet or outlet for passing a fluid through the separator plate, a flow field having an electrochemically active region and an intermediate fluid guide structure for guiding the fluid between the through-opening and the flow field. In principle, it is possible to provide all the functions of a separator plate within the separator plate, but it is also possible to divide some of the functions between the actual separator plate and a cell frame.

Separator plates in electrolyzers are usually single-layered, i.e. they are made from a single layer of a typically sheet metal material, for example by embossing, punching and/or deep drawing.

An important parameter of electrochemical systems is the efficiency achieved. This depends largely on how efficiently the electrochemical reaction is implemented. For example, the efficiency of an electrochemical system is reduced if the available reaction surface is very unevenly supplied with reactants. On the other hand, it is often not possible to change the reaction surface at will or to make other geometric adjustments within the surface of the separator plate.

The present disclosure is directed to the task of improving the efficiency of an electrochemical system.

This object is solved by the subject-matter described herein.

Accordingly, a separator plate for an electrochemical system is proposed, for example for an electrolyzer, having:

a first layer that has a first outer side and a first inner side, wherein a first channel-web structure is formed on the first outer side, the first channel-web structure having a plurality of channels and webs separating the channels, wherein the channel-web structure forms a complementarily-shaped second channel-web structure on the first inner side,

a second layer that has a second outer side and a second inner side, wherein the second inner side faces the complementarily-shaped second channel-web structure and defines therewith a plurality of internal channels,

a plurality of openings per internal channel, wherein the openings each define a fluid connection between a respective internal channel and the first channel-web structure on the first outer side,

wherein the number of openings within a first half of a total channel length of a respective internal channel, which can also be zero, is less than within a second half of the total channel length.

For example, the number of openings within the second half of the total channel length can be at least 20% or at least a third higher than in the first half. If the number within the first half is zero, the number of openings within the second half can be at least one. In general, the number of openings within the second half can be at least two, at least three, at least four or at least five.

According to the present disclosure, it was recognized that the efficiencies of existing electrochemical systems can be impaired for example by the fact that reaction products that are formed on the one hand dilute the reactants and on the other hand can accumulate in regions that are subsequently no longer sufficiently accessible for the desired electrochemical reaction to occur. In both cases, downstream reaction media can only reach these regions in too low a concentration, not at all or only to a limited extent, so that the desired electrochemical reaction is not realized to the desired extent.

In the case of electrolyzers, it was recognized that, for example, catalyst layers in the region of an anode of an electrochemical cell can be obscured by oxygen produced during the electrochemical reaction. Since water is typically fed along the anode as the reaction medium, the oxygen concentration along the flow path increases and the achievable local efficiency decreases progressively. The more oxygen is produced or, in other words, the higher the gas content, the more difficult it becomes for the supplied water to remove the oxygen. It is also more difficult for the water to penetrate a typically porous transport layer, PTL, on its way to the anode or the catalyst layer there. The increasing gas content also affects the local viscosity of the water-oxygen mixture and thus its local flow behavior. The proportion of water in the water-oxygen mixture generally decreases without further measures.

On the anode side of the electrolyzer's electrochemical cell, the water is typically in the liquid state of aggregation, the oxygen is in the gaseous state of aggregation and there is no hydrogen. The latter is only produced on the cathode side of the membrane. According to the above description, the gas content in the liquid water typically increases on the anode side, resulting in a mixture of liquid water and water enriched with gaseous oxygen. The adverse effects on viscosity described above may therefore be due in particular to the fact that the gaseous oxygen in this mixture is largely present as bubbles.

The present disclosure therefore proposes structural adaptations to separator plates, by means of which such disadvantages can be at least partially reduced. In particular, it is proposed to use the internal channels to supply a reaction medium, especially water, in particular in a liquid aggregate state, specifically in downstream regions or, in other words, to supply it locally. Viewed along the first web-channel structure, the reaction medium can therefore be fed in again locally, particularly after a certain channel length has already been passed through. This can increase the likelihood that reaction products can be sufficiently removed or, metaphorically speaking, washed away. In other words, the concentration of the reaction medium can be increased again after a significant flow through the first web-channel structure has already taken place and the proportion of reaction products can be reduced.

More precisely, the fact that the openings defining a fluid connection are unevenly distributed along the overall length of the channels can take account of the fact that the concentration of reaction products to be transported away is expected to increase in a flow direction along a longitudinal channel axis. When the reaction medium flows along the separator plate from the first half towards the second half of a total channel length, the higher number of openings defining a fluid connection in the second half means that the reaction products present there can be reliably removed. This means that a catalyst layer can still be reached to a sufficient extent.

The solution according to the present disclosure makes it possible to increase the cross-sectional region through which flow can pass on the anode side of the separator plate without having to increase the active region. The required installation space is also not significantly increased in the stacking direction.

The first channel-web structure can comprise or form a flow field. The flow field can define or be surrounded by an active region of an electrochemical cell, whereby the separator plate is part of this electrochemical cell. The electrochemical reaction can take place in the active region. The second channel-web structure may be complementary to the first channel-web structure in such a way that channels of the corresponding first structure form webs of the corresponding second structure and webs of the corresponding first structure form channels of the corresponding second structure.

Both the first and the second layer can be made of a similar material, for example, a sheet material. For example, it can be sheet metal coated on at least one side, at least in sections, or over the entire surface, for example made of titanium, stainless steel or other metals or metal alloys. These can therefore be plate-shaped components in which the respective channel-web structures are formed, for example, by forming and in particular by embossing processes. The first and second layers can be attached to each other, for example by means of a material bond such as one or more welded joints.

In general, features of the first channel-web structure can be described as external features and features of the second channel-web structure as internal features. For example, the openings of a respective internal channel can also form openings in a respective external channel and/or external web, e.g., they can open into these or start from these. Consequently, the fluid connections produced by the openings can be present in particular within an active region of the separator plate.

When reference is made here to a total channel length, this can be understood in particular as the length of a flow path specified or defined by the channel. For example, the channels may not necessarily be straight, but also curved and, in particular, multi-curved and, for example, wave-shaped. The total channel length can therefore correspond to the unwound length of a non-straight channel.

According to one embodiment, the internal channels each comprise a channel base, which merges into a side flank on each side, with at least one of the openings of a respective internal channel being formed at least partially in one of the side flanks. In particular, at least a portion of the opening cross-section can extend within one of the side flanks and/or overlap with it or, in other words, interrupt it locally. As a result of the complementary design, the channel base of an internal channel can form a web crest of the first channel-web structure on the first outer side. In this way, the fluid from the internal channels can pass directly into a fluid flow within the channels of the first channel-web structure.

Alternatively, or additionally, the internal channels can each comprise a channel base, which merges into a side flank on each side, whereby at least one of the openings of a respective internal channel is formed at least partially in the channel base. In particular, at least a portion of the opening cross-section can extend within the channel base and/or overlap with it or, in other words, interrupt it locally. In this way, it is possible to ensure that the fluid from the internal channels reaches the outside via the web crests on the outside and thus in closer proximity to the elements on the outside of the separator plate. For example, these adjacent elements, such as a permeable PTL, can lie directly against the web crests on the outside. In particular, it is also possible that at least one of the openings extends in sections in the channel base and at least one side flank.

The at least one opening in the channel base and/or in the side flank can have a first dimension along a longitudinal axis of the internal channel and a second dimension that runs transverse to the longitudinal axis of the channel. The first dimension can be at least one and a half times or can be at least two times the second dimension. In this way, an outflow direction of the fluid from the internal channels in a direction along the longitudinal axis of the channel can be supported. If several openings are arranged along a channel, these can have different shapes. The longitudinal axis of the channel can generally correspond to a flow path of a fluid along a channel. Accordingly, the longitudinal axis of the channel can also be curved and/or undulating, for example, depending on the extent of the channel.

By enlarging one of the second and first dimensions in relation to the corresponding other dimension, an oval shape of the opening can be defined, for example. Alternatively, other elongated shapes are also possible, such as crescent or lentil shapes. According to an alternative embodiment, the second dimension can be approximately or exactly as large as the first dimension. This corresponds to an essentially or completely circular shape of the opening.

Likewise, the edges of the opening do not have to be arranged in one plane, for example parallel to or in the plane of the panel. For example, an edge region of the opening, for example the downstream edge, can form a scoop-shaped projection that extends into the flow path, i.e. an internal channel, and thus facilitates the discharge from the internal channel into the external channel.

According to a further embodiment, the second layer is essentially flat, for example at least in a region opposite the second channel-web structure. For example, the second layer can be designed as a smooth sheet, at least in the region mentioned. In this way, an increase in thickness of the separator plate can be limited compared to known single-layer configurations. If other parameters are selected accordingly, it is even possible that a design according to the present disclosure can be implemented without requiring a large amount of installation space.

According to one variant, the first layer has a recessed receiving region for the second layer. This is particularly advantageous if the second layer spans a smaller area than the first. The receiving region can be designed to receive the second layer in such a way that it does not protrude from adjacent regions of the first layer and, in particular, is aligned with them. Thus, the separator plate can have a largely or completely flat outer side despite its two-layer configuration, whereby this outer side faces away from the first web-channel structure. It has been shown that a flat outer surface-in combination with suitable sealing elements-is well suited for conducting the hydrogen produced on the cathode side.

According to a further embodiment, one of the first layer and the second layer has a plurality of through-openings, each of which is connected to the first and/or the second channel-web structure in a fluid-conducting manner. For example, the channels of the first channel-web structure and, if necessary, also the internal channels can connect the through-openings within the separator plate in a fluid-conducting manner. In particular, at least the channels of the first channel-web structure can extend between two through-openings and connect them to each other in a fluid-conducting manner. In a manner known per se, a reaction medium can be guided through a through-opening, and can pass into the channels and be guided by these, for example after passing through the active region, in the direction of the corresponding other through-opening. In general, the through-openings can be configured to pass a fluid through the separator plate and/or through a stack of separator plates, for which purpose the through-openings of the individual separator plate can be aligned with each other.

Accordingly, a further development provides that the one of the first and second layers that does not have the through-openings has a smaller surface area than the other one of the first and second layers. The area can be a base area of the corresponding layer and/or an area size of the outer side and/or inner side of the corresponding layer. By reducing the surface area accordingly, for example, the layer can be dimensioned in such a way that it can sufficiently delimit the internal channels. This limits the material consumption and weight of this layer and therefore of the entire separator plate. On the one hand, it is possible for the first and second layer to have the same sheet thickness. On the other hand, for example if the smaller layer is received in a shoulder and/or a recessed receiving region of the larger layer, the smaller layer can be made of a thinner sheet than the larger layer.

According to a further development, the first layer has the through-openings and a region of the second layer is less than one and a half times as large as a region of the first layer in which the first channel-web structure extends.

One embodiment provides for the second layer to be connected, in a region surrounding the second channel-web structure, for example in a frame-like manner, to the first layer in a materially bonded or otherwise fluid-tight manner. In addition, web crests of this second channel-web structure can also be connected to the second layer, for example in sections or along short connecting lines. The web crests can form regions of the second channel-web structure that protrude at least locally furthest in the direction of the second layer. For example, these web crests lie in the same plane as the frame-shaped region of the first layer that surrounds the second channel-web structure.

For example, a web crest and a web flank of the second channel-web structure, together with an inner side of the second layer and, furthermore, the next web flank, can in this way continuously delimit a respective internal channel. Figuratively speaking, the inner side of the second layer can therefore form one side or side wall of, for example, four sides or side walls of a cross-sectional profile of a respective internal channel. The remaining sides or side walls can be formed by the second channel-web structure. This represents a space-saving solution for forming the internal channels, whereby materially bonded connections can also be reliably produced in the region of the web crests.

In a further development, the first half of the total channel length of each internal channel is located upstream of the second half. This can apply, for example, if the separator plate and the electrochemical system are used and/or operated as intended. In such a case, a fluid may initially be guided proportionally along the first half of each internal channel as well as along the first half of each channel of the first channel-web structure, i.e. the external channels, for example after exiting a through-opening. It can then pass proportionally into the second half of the total channel length of the internal channels or into the second half of the channels of the first channel-web structure.

According to a further embodiment, the number of openings within the first half or within the first at least 30% or within the first at least 20% of the total channel length of each internal channel is zero. In other words, no openings can be formed there and consequently no direct fluid connection between an internal channel and the outside can exist. This can take account of the fact that in these regions the electrochemical reaction has not yet taken place to such an extent that the proportion of reaction products can reduce the efficiency. Such a reduction in efficiency can only occur if the channel length is sufficiently advanced, so that the openings and fluid connections may only be provided there. In this way, pressure losses and/or flow resistance, which the openings and fluid connections inevitably entail, can be limited.

On the other hand, the number of openings, in particular per internal channel, within the second half of the total channel length of each internal channel can be at least two or at least three, for example.

According to a further embodiment, the number of openings within the second half of the total channel length is at least 50% higher than within the first half of the total channel length and may be at least 100% higher. If the number of openings within the first half is zero, the number of openings within the second half can be at least 1.

Additionally or alternatively, the distance between successive openings can be inhomogeneous, at least within the second half of the total channel length. For example, the distance between successive openings can decrease, at least in sections, when viewed in a direction from the first to the second half of the total channel length. This can take into account the fact that the concentration of the reaction products increases successively along the total channel length and in particular in the direction of and along the second half. Accordingly, the distance between the openings can decrease in the direction from the first to the second half (and along the second half), at least in sections, and/or continuously.

According to a further embodiment, the internal channels each have a first end at the beginning of the first half of the total channel length and a second end at the end of the second half of the total channel length, wherein a flow cross-section of the second end is between at least 50% less and up to and including 100% less than an average flow cross-section within the first and/or second half of the total channel length and is therefore closed. The first and second halves of the total channel length can merge or adjoin each other in a central position of the total channel length. The first and second ends of a respective internal channel can each be spaced from this center position by one half of the total channel length. For non-rectilinear channels, a distance at uncoiled length and/or a distance along a non-rectilinear longitudinal channel axis can be considered.

Due to the reduced flow cross-section of the second end, a targeted dynamic pressure can be generated within a respective internal channel, which can force a fluid guided therein out through the opening towards the outside. In particular, this dynamic pressure can enable the fluid to escape from the openings even with corresponding counterpressure on the outside and/or prevent the reverse flow of fluid from the outside into the internal channels. The average flow cross-section within one half of the total channel length is advantageously determined by those sections that are free of openings.

On the other hand, the first end of a respective internal channel can be open and can have a flow cross-section that is at least as large as the average flow cross-section within the first and/or second half of the total channel length. This can enable a reliable flow of fluid into the internal channels. In addition or alternatively, the first end can generally have a larger flow cross-section than the second end if the latter is not completely closed, for example a flow cross-section that is at least 50% or at least 100% larger.

According to a further development, the openings of a respective internal channel have different cross-sectional sizes and/or cross-sectional shapes. In general, these can be formed differently from one another. This allows the openings to be adapted, for example, to the respective local concentrations of reaction products and/or flow and pressure conditions, particularly on the first outer side, for example to enable an effective inflow of fluid from the internal channels to the first outer side. For example, the cross-sectional sizes can increase with increasing distance from a first end of the internal channels mentioned above.

According to a further development, viewed in a flow direction that runs along a longitudinal channel axis and from the first half of the total channel length in the direction of the second half and/or that runs from the first to the second end of a respective internal channel as described above, at least one of the openings has a radially inner circumferential section and a radially outer circumferential section. The radial positioning can refer to a positioning transverse to the longitudinal axis of the channel and, for example, the radially inner circumferential section can be indented radially in relation to the radially outer circumferential section. The peripheral sections can each comprise or form edge regions of the opening or edge sides of the separator plate that border the opening. The radially inner circumferential section may be arranged downstream of the radially outer circumferential section. This can be synonymous with the fact that, viewed in a top view and/or a sectional view containing the longitudinal axis of the channel, the at least one opening has a radially stepped edge. This can help fluid to escape from the internal channel to the outside.

One embodiment provides that, in the region of at least one of the openings of a respective internal channel, a flow cross-section of the internal channel is reduced, at least in sections. Once again, it can be provided that this narrows, at least in sections, when viewed in the direction of flow.

According to a further development, at least one of the openings of a respective internal channel is arranged to define or, in other words, to generate a fluid flow in a direction directed away from the first outer side, i.e. the opening surface. This can mean that a vector component of the flow direction in a direction orthogonal to the first outer side in the region of the opening is at least as large as a vector component in a direction parallel to the first outer side in the region of the opening. In this way, the fluid flow can be directed specifically towards a component that is in contact with the first outer side in the region of the opening, such as a PTL in particular.

Examples of embodiments of the separator plate are shown in the attached schematic figures and are explained in more detail in the following description. Recurring features can be designated with the same or similar reference signs across the figures. Only selected instances of a feature shown several times within a figure may be provided with a reference sign assigned to this feature. In the figures:

### BRIEF DESCRIPTION OF THE FIGURES

FIG. 1 is an exploded view of an individual cell of an electrolyzer having two separator plates according to the state of the art.

FIG. 2 is a perspective view of a single separator plate according to an embodiment of the present disclosure.

FIG. 3 is a detailed view of the separator plate from FIG. 2.

FIG. 4 is a partial sectional view of the separator plate from FIG. 2.

FIG. 5 is a further detailed view of the separator plate from FIG. 2.

FIGS. 6A & 6B are sectional views of a single internal channel, as it can be formed in separator plates according to embodiments of the present disclosure, in a non-flowed-through state (FIG. 6A) and in a flowed-through state (FIG. 6B).

FIGS. 7A & 7B are sectional views of a single internal channel, as may be formed in separator plates according to embodiments of the present disclosure, in a non-flowed-through state (FIG. 7A) and in a flowed-through state (FIG. 7B).

FIGS. 8A & 8B are sectional views of a single internal channel, as it can be formed in separator plates according to embodiments of the present disclosure, in a non-flowed-through state (FIG. 8A) and in a flowed-through state (FIG. 8B).

FIGS. 9-11 are each a cross-sectional view of a single internal channel, as may be formed in separator plates according to embodiments of the present disclosure.

FIGS. 12 & 13 are each a cross-sectional view of a single internal channel, as may be formed in separator plates according to embodiments of the present disclosure.

FIG. 14 is a schematic representation of a separator plate according to a further embodiment of the present disclosure.

FIG. 15 is a schematic top view of several internal and external channels along their course, as they can be formed in separator plates according to embodiments of the present disclosure.

### DETAILED DESCRIPTION

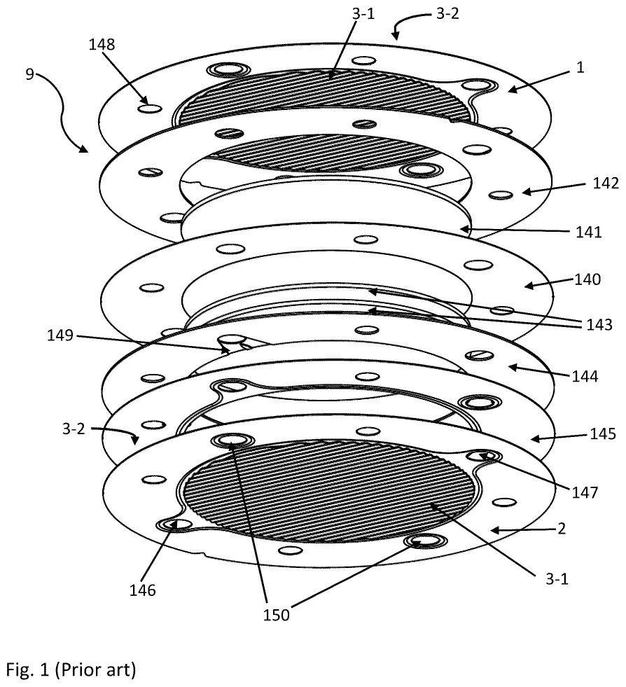

FIG. 1 shows an exploded view of an electrochemical single cell 9 according to the state of the art, whereby the single cell 9 is part of an electrolyzer. Electrolyzers typically comprise a large number of stacked individual cells 9. The individual cell 9 comprises two separator plates 1 and 2, two cell frames 142 and 144, a sealing layer 145, a membrane electrode arrangement 140 with catalyst materials and media diffusion structures 141 and 143. The media diffusion structure 143 comprises, for example, layers of carbon non-woven material, while the media diffusion structure 141, which forms a previously mentioned PTL, comprises metal, e.g. titanium. Here, the separator plate 1 is arranged, for example, on the anode side of the individual cell 9. In the exemplary embodiment shown, the separator plate 2 is arranged on the cathode side of the individual cell 9. The individual components are pressed together to form an individual cell. The individual components each have fluid feedthroughs 146, 147, 150 (also referred to as through-openings) arranged in alignment one above the other for feeding water, oxygen and hydrogen in and out, as well as positioning holes 148.

A flow field 3-2 and an active region of the separator plate 2 are defined by projecting the cell frame 144 onto the separator plate 2. A flow field 3-1 and active region of the separator plate 1 are defined by projecting the cell frame 142 onto the separator plate 1.

A typical operating condition that may be implemented in any of the embodiments disclosed herein may include, in particular, the following: The anode side of the single cell 9 is supplied with water in a liquid aggregate state. In the course of the flow path in flow field 3-1, oxygen is produced in the gaseous aggregate state, whereby a liquid-gas mixture of water and oxygen is formed on the anode side. The oxygen concentration in the liquid-gas mixture on the anode side increases along the flow path in flow field 3-1. The liquid-gas mixture is discharged via selected ones of the fluid feedthroughs 146, 147, 150. On the cathode side, hydrogen is generated in a gaseous aggregate state and is also discharged via selected fluid feedthroughs 146, 147,150.

In the region of the flow fields 3, the separator plates 1, 2 each have channel-web structures with fluid-conducting channels and webs separating these channels. The separator plates 1, 2 in FIG. 1 are single-layer components formed from a thin sheet material. The channel-web structures are formed complementarily on the back and front of each separator plate 1, 2. This means that webs on a respective rear side form channels on a respective front side (and vice versa) and channels on a respective rear side form webs on a respective front side (and vice versa). For example, the rear side can be understood as a side that faces the inside of a respective cell.

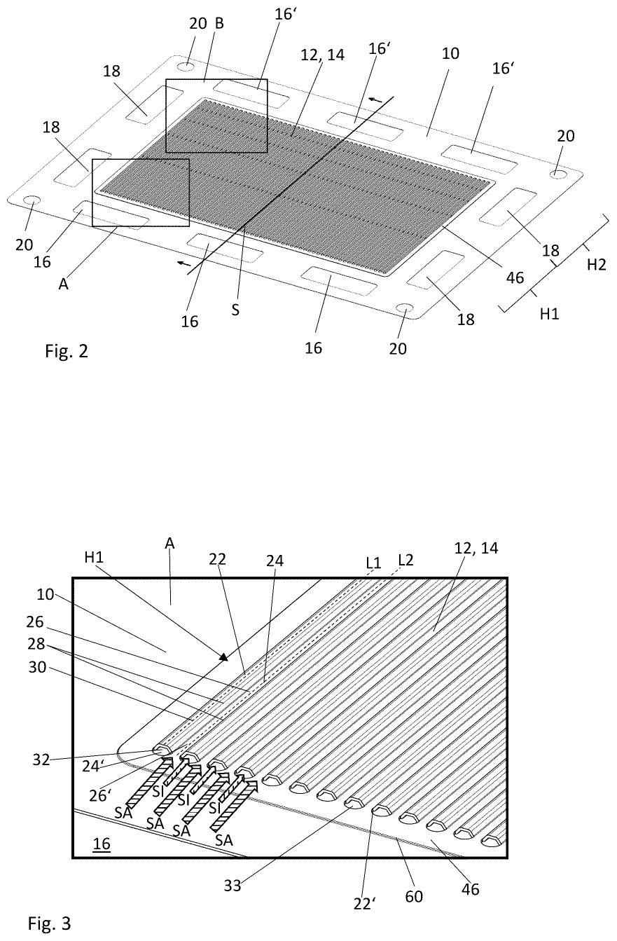

The cell frame 142 has distribution channels (not shown) for distributing the water that is fed in. The through-openings 146, 147 are in fluid communication with the flow field 3-2 so that a medium can be directed from the through-opening 146 to the flow field 3-2 or from the flow field 3-2 to the through-opening 147. When a potential is applied, hydrogen (or oxygen) can be generated in the electrolyzer from the supplied water. This can be discharged through the distribution channels 149 in the cell frame 144. It can then leave the cell through the through-openings 150. While the separator plates 1 shown in FIG. 1 have a round outer contour, other shapes are also possible. For example, the separator plates 1, 2 can have a rectangular outer contour (see also FIG. 2).

If water flows along the visible side of the flow field 3-1 of the separator plate 1, the oxygen produced can make it increasingly difficult for the water to reach the adjacent MEA 140 to the desired extent as the flow path progresses. This reduces the extent of the electrochemical reaction that takes place and therefore the efficiency of the electrolyzer.

FIGS. 2-15 illustrate embodiments of the present disclosure, with which such problems can be limited. These embodiments can be operated in particular according to the operating state explained above, i.e. on the anode side with liquid water and increasing gaseous oxygen concentration in a water-oxygen mixture/liquid-gas mixture there, but without hydrogen, and with hydrogen on the cathode side without a water-oxygen mixture there. FIG. 2 shows an example of a rectangular separator plate 10. This is a component of an electrochemical cell of an electrolyzer constructed in principle as shown in FIG. 1. The separator plate 10 shown can be arranged with its first surface on an anode side, analogous to the separator plate 1 in FIG. 1. One side of the separator plate 10, which can be brought into contact with a PTL, is facing the viewer in FIG. 2. A flow field 12 with a first channel-web structure 14 is formed on this side. The separator plate 10 of FIG. 2 can be combined with one or more cell frames and/or with sealing layers, as shown in FIG. 1, but other arrangements-without cell frames and/or without sealing layers-are also possible; the corresponding details of the periphery of the separator plate 10 will not be considered here.

The separator plate 10 again comprises several through-openings 16, 16′, 18 and mounting holes 20. The through-openings 16 are used to supply water, and the through-openings 16′ are used to discharge oxygen and water. The through-openings 18 are used to discharge hydrogen. They are fluidically sealed against the first channel-web structure 14 and the fluids conducted therein via sealing structures (not shown).

FIG. 3 shows an enlarged view of a partial region A from FIG. 2. The individual webs 22 and channels 24 of the first channel-web structure 14 are recognizable. Each channel 24 comprises a channel base 26, which merges into a side flank 28 on each side. The webs 22 comprise web crests 30, which also merge into adjacent side flanks 28 on both sides. The webs 22 and channels 24 are each rectilinear, which is not mandatory, and extend along longitudinal axes L1, L2 that are parallel to each other.

Furthermore, it can be seen that the first channel-web structure 14 forms a complementary second channel-web structure 32 on the side that faces away from the viewer. This comprises a corresponding complementary arrangement of internal channels 24′ and internal webs 22′.

The end 33 of the webs 22 of the first channel-web structure 14 that faces the viewer, which also forms a first end 33 of the internal channels 24′, is open. As indicated by arrows SA, S1, the supplied water can thus flow both along the outer channels 24 and along the internal channels 24′.

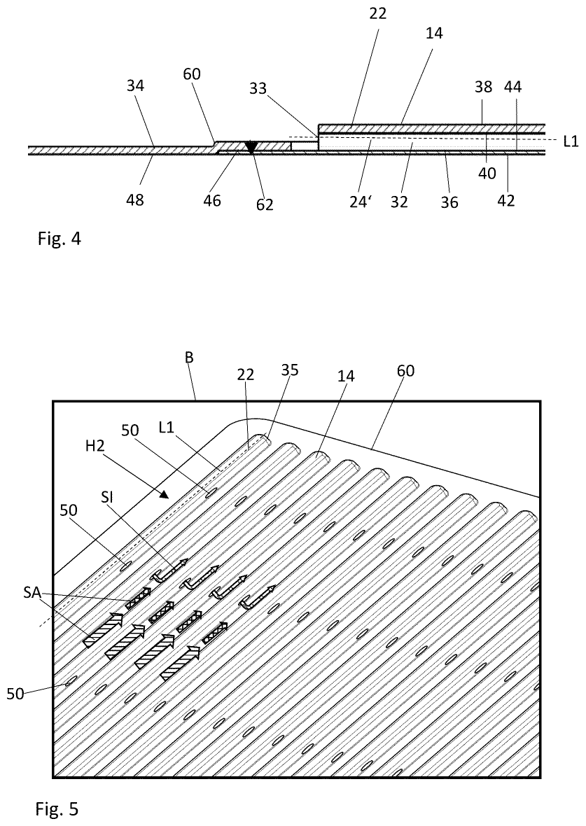

This relationship is further illustrated in FIG. 4, which is a cross-sectional view along part of a sectional axis S from FIG. 2. More precisely, this sectional axis S runs centrally through one of the webs 22 of the first channel-web structure 14 and along its longitudinal axis L1, see FIG. 3.

FIG. 4 shows that, in contrast to known prior art solutions, the separator plate 10 is designed with two layers, namely in the region of the flow field 12 and extending slightly beyond it. More precisely, it comprises a first layer 34 and a second layer 36. These are each made from single-layer sheets and attached to each other, for example by welding. The layers 34, 36 and in particular at least their center planes and/or planar surface planes, which comprise undeformed regions of the respective layers 34, 36, extend substantially parallel to one another.

The first layer 34 comprises a first outer side 38 and a first inner side 40 that faces away from the first outer side 38. These form correspondingly opposite first and second surfaces of the first layer 34. The second layer 36 comprises a second outer side 42 and a second inner side 44 that faces away from the second outer side 42. These form a corresponding opposite first and second surfaces of the second layer 36. The first outer side 38 and the second outer side 42 face away from each other. They form, at least partially, opposite surfaces or outer sides of the separator plate 10, for example a front side and a rear side. The first inner side 40 and the second inner side 44 are opposite each other. Together they delimit the internal channels 24′. Such internal channels 24′ are not present in known single-layer separator plates according to the state of the art, since no comparable second layer 36 is provided there.

In the example shown, the first layer 34 has a larger surface area than the second layer 36. The first layer 34 comprises, for example, all of the through-openings 16, 16′, 18 and mounting holes 20 shown in FIG. 2.

In the example shown, the second layer 36 extends opposite the flow field 12 of the first layer 34, but only extends slightly beyond it. As an optional feature, the first layer 34 has a step 60 in the region that bounds the outer edge of the second layer 36, which forms a recessed receiving region 46 for the second layer 36. This recessed receiving region 46 surrounds the flow field 12 like a frame, see FIGS. 2 & 3. The second layer 36, on the other hand, is flat and is inserted into the recessed receiving region 46. The rear side of the separator plate 10 (facing downwards in FIG. 4) is therefore essentially flat, since the second outer side 42 of the second layer 36 is aligned with an adjacent region of the first outer side 40 of the first layer 34. This adjacent region 48 surrounds the second layer 36 like a frame and comprises the through-openings 16, 16′, 18 and mounting holes 20 from FIG. 2. The flatness of the back of the separator plate 10 improves the compressibility of a stack of several electrochemical cells and helps to reduce the resulting stack height.

FIG. 4 also shows a weld seam 62, which connects the two layers 34, 36 to each other in a fluid-tight manner around the flow field 12. This ensures that the anode chamber and the cathode chamber are fluidically separated from each other. The weld 62 extends adjacent to and spaced from the outer edge of the second layer 36 and the step 60 of the first layer 34. For reasons of clarity, the weld seam 62 is not shown in FIGS. 2, 3 and 5.

As a further optional feature, it is shown that the first layer 34 is at least 1.5 times or at least two times as thick as the second layer 36 or, in other words, has a correspondingly increased material thickness. The second layer 36 is well supported by a flat support, for example on a GDL, whereas the first layer 34 must withstand the pressure of the media in the channel-web structures 14, 32, so that a greater material thickness is advantageous.

It is not separately recognizable in FIG. 4 that the second inner side 44 of the second layer 36 rests against internal webs 22′ of the second web-channel structures 32 and is optionally also fastened there, at least locally, for example is fastened by material bonding such as by welding.

FIG. 4 again shows the open end 33 of the webs 22 and internal channels 24′, through which water flows into the internal channels 24′.

FIG. 5 shows an enlarged view of a partial region B from FIG. 2. This partial region B contains the second ends 35 of the webs 22 of the first channel-web structure 14, which are opposite the first open ends 33 and which also form second ends 35 of the internal channels 24′. These second ends 35 are closed, which means that the internal channels 24′ are also closed at their second ends 35. This creates a back pressure within the internal channels 24′, which presses the water flowing in the internal channels 24′ out of those channels to the first outer side 38. For this purpose, the first layer 34 has a plurality of openings 50, which establish fluid connections between its first inner side 40 and first outer side 38.

By way of example only, these openings 50 are arranged in the side flanks 28 of the first channel-web structure 14 and thus also of the second channel-web structure 32. The openings 50 are thus arranged in the region of the internal channels 24′ and connect each of these with an adjacent channel 24 on the first outer side 38 of the separator plate 10. In FIG. 5, openings 50 are only visible on the side flanks 28 that face the viewer. The side flanks facing away from the viewer could also have openings or could have no openings at all.

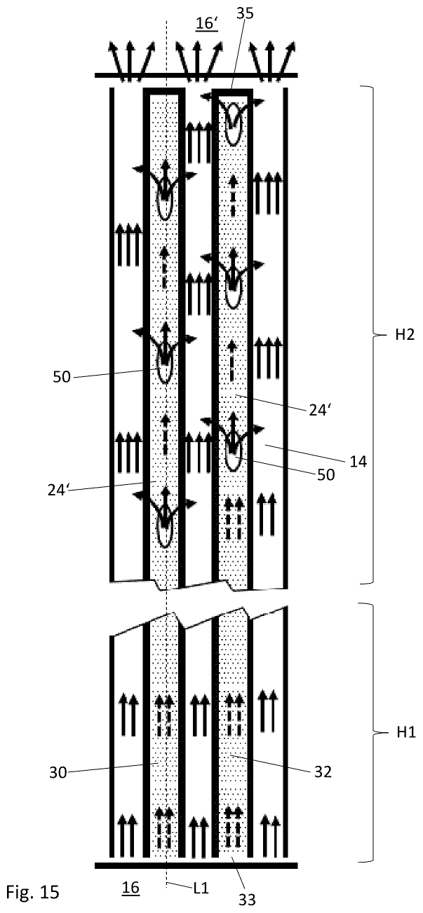

A combined view of FIG. 3, FIG. 2 and FIG. 5 shows that the number of openings 50 near the second end 35 of a respective web 22 is higher than the number of openings near the open first end 33, where no openings 50 are present. Accordingly, the number of openings 50 per internal channel 24′ also increases along its course from the first end 33 to the second end 35. More specific examples of possible numbers and/or distributions of openings 50 along the total channel length of a respective internal channel 24′ have already been mentioned above and are also set out in more detail in the claims. What these examples have in common is that the number of openings 50 in a second half H2 of the total channel length, which extends to the second end 35, is higher than in a first half H1 of the total channel length, which extends from the first end 33. The halves H1 and H2 are marked as an example in FIG. 2. In the present example embodiment, the first half H1 has one opening 50 per internal channel 14′ and visible side flank 28, while in the second half there are three openings 50 per internal channel 14′ and visible side flank 28. In particular, there can also be no openings 50 within this first half H1 and accordingly no targeted fluid discharge can occur there from the internal channels 24′ to the first outer side 38 of the separator plate 10 or from its first layer 34, see FIG. 15. As described above, such a fluid discharge is only made possible with increasing flow distance of the water entering the open end 33 and is increasingly forced to occur by a correspondingly increasing number of openings 50, since the oxygen concentration on the first outer side 38 also increases when viewed along this flow direction (i.e. increases from the first end 33 towards the second end 35).

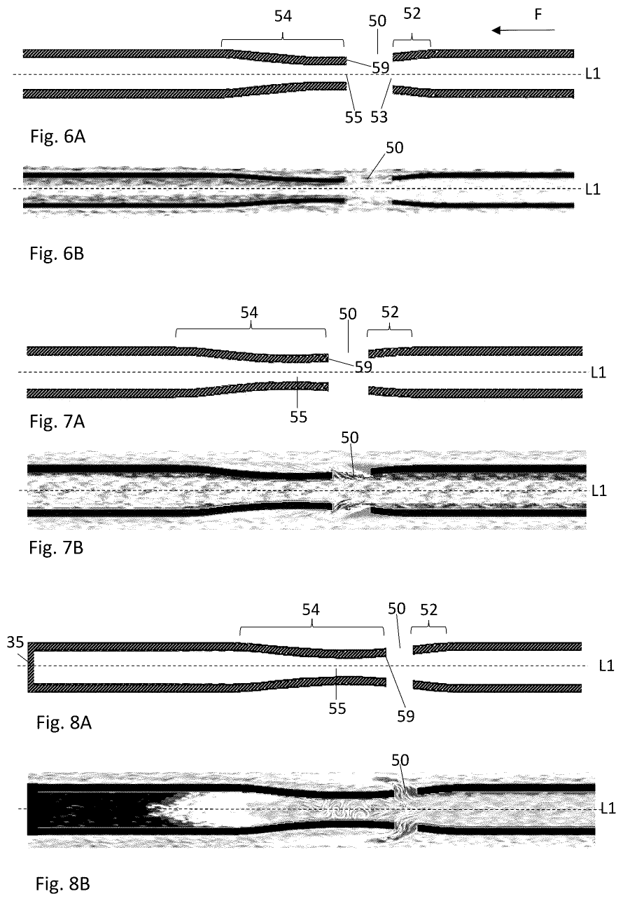

FIGS. 6A-8B each show sectional views of a section of a single internal channel 24′ in the region of one of the openings 50. The respective sectional plane contains the longitudinal axis L1 of FIGS. 3 and 4 or runs parallel to it. In addition, the sectional plane runs parallel to the second and/or first layer 34, 36. The examples of FIGS. 6A-8B may be provided for at least individual openings 50 as well as alone or in any combination for a respective internal channel 24′ of the examples disclosed herein.

FIGS. 6A, 7A and 8A each show an unfilled internal channel 24′, in which no water flows. FIGS. 6B, 7B and 8B show the corresponding internal channels 24′ in a filled state, i.e. with water flowing in them. In FIG. 6A, a flow direction is marked with an arrow F, whereby the same flow direction also applies to the remaining FIGS. 6B-8B.

In the example of FIGS. 6A-6B, a channel section located upstream of the opening 50 has a flow cross-section-constricting region 52, whose flow cross-section successively decreases when viewed in the flow direction F. Downstream of the opening 50, on the other hand, the internal channel 24′ has a flow cross-section-enlarging region 54, the flow cross-section of which is initially constant when viewed in the flow direction F before it gradually increases again. The smallest flow cross-section 53 of the flow cross-section constricting region 52, which in the example shown is directly adjacent to the opening 50, is larger (for example at least 5% larger) than the smallest flow cross-section 55 of the flow cross-section enlarging region 54, which is also directly adjacent to the opening 50.

The respective edges of the regions 52, 54 adjacent to the opening 50 can form circumferential sections which are at radially different levels in relation to the longitudinal axis L1. More precisely, there may be a radially wider outer circumferential section upstream of the opening 50 than downstream. Viewed in the direction of flow, the circumference or edge of the opening 50 is thus radially stepped and may be radially indented downstream.

The above configuration enables the water emerging from the flow cross-section-constricting region 52 to emerge from the opening 50 into the adjacent channels 24 of the first web-channel structure 14 in a defined manner and to pass into the flow cross-section-enlarging region 54 only to a correspondingly reduced extent.

The example of FIGS. 7A-7B is largely analogous to the example of FIGS. 6A-6B, with the difference that a smallest cross-section 55 of the flow cross-section-enlarging region 54 is located at an axial distance from the opening 50. Starting from the opening 50, a flow cross-section of the flow cross-section-enlarging region 54 initially decreases successively to the smallest cross-section 55 before it then increases again. This change in cross-section is reflected in a limited back pressure. The edge 59 of the opening 50, which represents the beginning of the region 54, also protrudes further into the internal channel 24′ than is the case in FIGS. 6A-6B. In addition, a more pronounced taper results in the flow cross-section-restricting region 52 of FIG. 7A and 7B than in FIGS. 6A-6B. Together, these factors cause a higher proportion of water to discharge from an internal channel 24′ into the adjacent channels 24 of the first web-channel structure 14.

The example of FIGS. 8A-8B is largely analogous to the example of FIGS. 7A-7B, with the difference that an axial opening width of the opening 50 is smaller than in FIG. 7A. The region of the internal channels 24′ that is to the left, i.e. downstream, with respect to the outer channels 24, also ends at the closed second end 35 of the webs 22, so that a large back pressure forms in this region, which in summary leads to the fact that all of the water flowing in the internal channels 24′ from the right to the openings 50 exits through these openings.

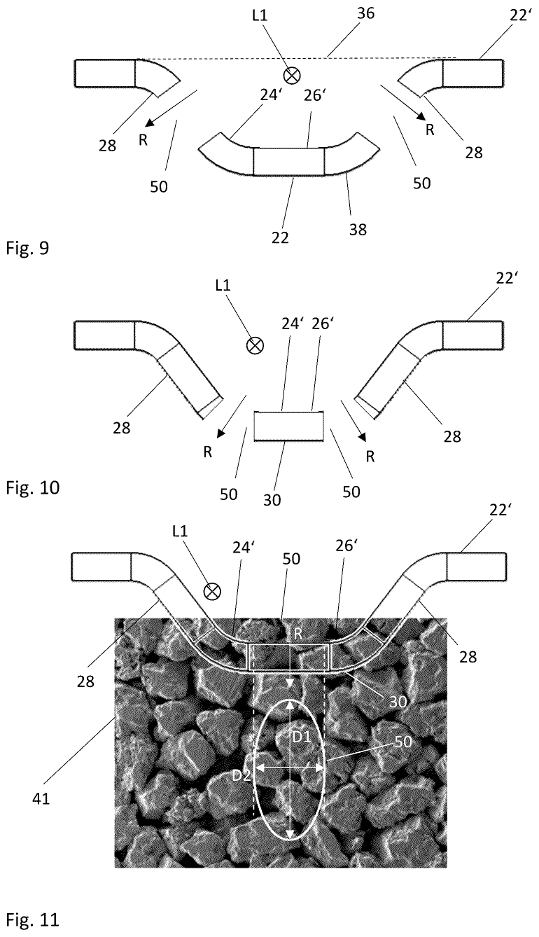

FIGS. 9-11 show further sectional views of selected webs 22 of the first web-channel structure 14. Webs 22 formed in this way can be provided in combination with all of the embodiments described above. The sectional plane is perpendicular to the longitudinal axes L1, L2 of the previous figures, see in particular FIG. 3. However, compared to the view in FIG. 4, for example, the orientation is changed in such a way that the first outer side 38 of the separator plate 10 faces downwards. Accordingly, the internal channels 24′ face upwards. The extension of the second layer 36 is indicated only in FIG. 9.

FIG. 9 shows an example in which openings 50 are formed in the side flanks 28. This corresponds to the variant shown in FIGS. 2-5.

In FIG. 10, the openings 50 are formed in a transition region between the side flanks 28 and the web crest 30/a channel base 26′ of the shown internal channel 24′. An outlet direction R of the water from the internal channel 24 is relatively more strongly inclined toward a PTL resting against the web crest 22, i.e. is inclined more strongly in an orthogonal direction to a plane of the separator plate 10. This can support a kind of flushing of the PTL and thus bring more water into contact with the catalyst materials of the neighboring MEA.

In FIG. 11, an opening 50 is formed in the web crest 30/the channel base 26′ of the internal channel 24′ shown. In FIG. 11, as in all of FIGS. 9 and 10, several of the openings 50 shown can be distributed along the channel or web lengths.

The fluid emerges, from the openings 50 positioned as shown in FIG. 11, essentially orthogonally to the surrounding surfaces of the web crest 30 and channel base 26′. FIG. 11 also shows a top view, tilted towards the viewer, of the opening 50, together with an illustration of its cross-sectional dimensions. The cross-section here is oval. A first dimension D1, which runs along the longitudinal axis and thus in the direction of flow, is larger than a second dimension D2, which runs transverse to the longitudinal axis and thus the direction of flow. This increases the volume flow of the exiting water.

Also shown is a section of a PTL or, in general terms, a media guiding structure 41, which rests against the web crest 30 in the region of the opening 50. It can be seen, that the opening 50 is significantly larger than granular solid regions of the PTL and thus overlaps with several porous regions/pore widths of the PTL (shown in black). In particular, an opening area of the opening 50 is larger than an average pore width of the PTL, for example at least four times as large.

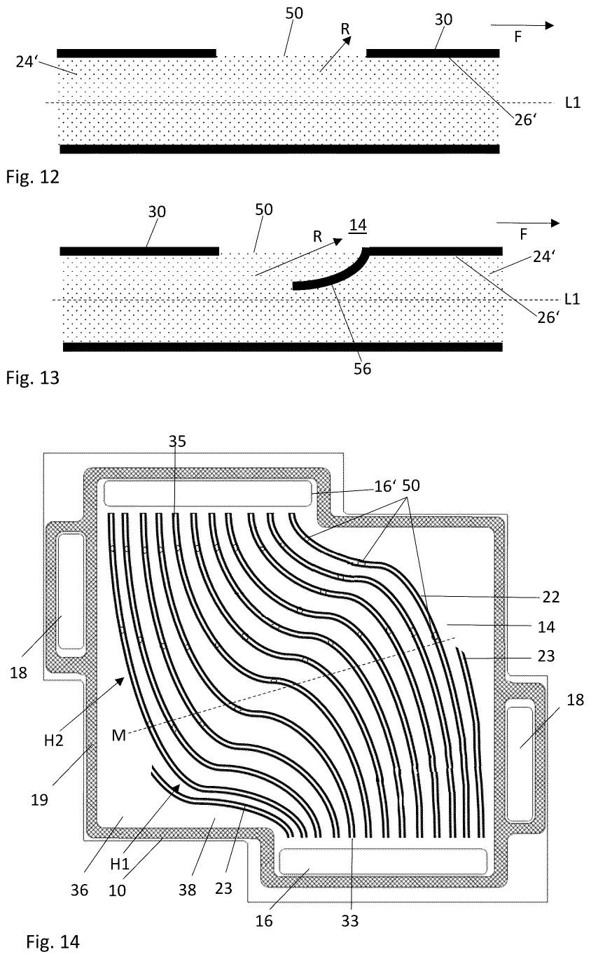

FIGS. 12 and 13 show two alternative designs of a separator plate 10 according to further embodiments. While the cross-sections in FIGS. 9-11 show cross-sections orthogonal to the longitudinal axis L1 of the channel, the cross-sections in FIGS. 12 and 13 run parallel to the longitudinal axis L1 of the channel. FIG. 12 shows an opening 50 in which the edge regions surrounding it extend in the same plane, parallel to the plate plane/the channel base 26′. FIG. 13, on the other hand, shows an opening into which a cap 56 projects on the downstream side. This cap enables water to be selectively discharged from an internal channel 24′ to the outside, i.e. into the first channel-web structure 14, in order to increase the water content there.

FIG. 14 shows an alternative design of a separator plate 10 according to a further embodiment example. The separator plate 10 is basically designed in the same way as the previous examples, including two layers. Facing the viewer is the first outer side 38 of a first layer 34, which in turn has a first channel-web structure 14. Several openings 50 are formed in the webs 22 of this first channel-web structure 14, which establish fluid connections to internal channels 24′ that are not visible. Furthermore, the first end 33 of the webs 22 of the first channel-web structure 14 and thus also of the internal channels 24′ are open. These first ends 33 are close to a through-opening 16, from which water passes into the channel-web structure 14 and, through the open ends 33, also into the internal channels 24′.

The water flows along the channel-web structure 14 to an opposite through-opening 16′. Furthermore, it is shown that the separator plate 10, and in particular its first layer 34, also has further through-openings 18, which are however fluidically sealed off from the first channel-web structure 14 and the through-openings 16, 16′ by a seal 19.

The webs 22, and thus also the internal channels 24′, are curved and, by way of example, run asymmetrically in an S-shape to their second ends 35, which in turn are closed. A total channel length of the internal channels 24′ is measured as a flow path of the water along the internal channels 24 and not as a straight line distance between their first and second ends 33, 35. This can also be understood as a consideration of the unwound length of a respective internal channel 24′.

A line M is shown, which connects approximate center positions of a respective total channel length of each internal channel 24′ and thus also of each web 22—with the exception of optional outermost webs 23. A first half H1 of the total channel length extends from a respective first end 33 to a center position indicated by the line M. A second half H2 of the total channel length, which lies downstream of the first half, extends from this center position to a respective second end 35.

It can be seen that the openings 50 are positioned differently for each web 22 and thus for each internal channel 24′. Several of the internal channels 24′ have no openings 50 along their first half H1. Others have only one opening 50 or only a portion of an opening 50. On the other hand, all internal channels 24′ have several openings 50 along their second half H2 of the total channel length. Thus, along a flow path along the first channel-web structure 14, water can be increasingly supplied or also supplied from the internal channels 24′ with increasing proximity to the second end 35 in order to achieve the previously explained increases in efficiency.

Only two outermost and comparatively short webs 23 are also shown by way of example, which have no openings 50 along their entire length.

FIG. 15 shows a two-part top and through view of first and second channel-web structures 14, 32. The crests 30 of the second channel-web structure 32 are only indicated by their first and second ends 33, 35 and the openings 50. While the first ends 33 are open and essentially correspond to the central channel cross-section, the second ends 35 are closed. In the first half H1—which is intentionally drawn smaller in order to have sufficient space available for a clear representation of the second half-of an internal channel 24′, there are no openings in the web crests 30. In the second half H2, however, the web crests 30 have openings 50 that allow water to flow out of an internal channel 24′. In the present embodiment example, the openings 50 within a web crest 30 are arranged equidistantly, but offset relative to the openings 50 of the nearest web crest 30. This enables a uniform supply of water to the intervening channels 24 of the first channel-web structure 14, whereby the material of the webs has sufficient stability. With regard to the shape of the openings, the openings 50 essentially correspond to those in FIG. 11 and are arranged in the region of the web crests 30.

1. A separator plate for an electrochemical system, comprising:
a first layer that has a first outer side and a first inner side, wherein a first channel-web structure is formed on the first outer side, the first channel-web structure having a plurality of channels and webs separating the channels, wherein the first channel-web structure forms a complementarily-shaped second channel-web structure on the first inner side,
a second layer that has a second outer side and a second inner side, wherein the second inner side faces the complementarily-shaped second channel-web structure and defines therewith a plurality of internal channels,
a plurality of openings per internal channel, wherein the openings each define a fluid connection between a respective internal channel and the first channel-web structure on the first outer side,
wherein the number of openings within a first half of a total channel length of a respective internal channel is less than the number of openings within a second half of the total channel length.

2. The separator plate according to claim 1,
wherein the internal channels each comprise a channel base, which merges on each side into a respective side flank, wherein at least one of the openings of a respective internal channel is formed at least partially in one of the side flanks.

3. The separator plate according to claim 1,
wherein the internal channels each comprise a channel base, which merges on each side into a respective side flank, wherein at least one of the openings of a respective internal channel is formed at least partially in the channel base.

4. The separator plate according to claim 2,
wherein the at least one opening in the side flank has a first dimension along a longitudinal channel axis of the internal channel, and a second dimension, that extends transversely to the longitudinal channel axis,
wherein the first dimension is at least one and a half times the second dimension.

5. The separator plate according to claim 1,
wherein the second layer is substantially flat at least in a region opposite the second channel-web structure.

6. The separator plate according to claim 1,
wherein one of the first layer and the second layer has a plurality of through-openings, which are each connected in a fluid-conducting manner to the first and/or the second channel-web structure.

7. The separator plate according to claim 6,
wherein one of the first layer and the second layer does not have the through-openings and has a smaller area than the other one of the first layer and the second layer.

8. The separator plate according to claim 1,
wherein the second layer is connected, in a region surrounding the second channel-web structure, to the first layer in a materially bonded or otherwise fluid-tight manner.

9. The separator plate according to claim 1,
wherein the first half of the total channel length of each internal channel is upstream of the second half.

10. The separator plate according to claim 1,
wherein the number of openings per internal channel within the second half is at least two.

11. The separator plate according to claim 1,
wherein the internal channels each have a first end at the beginning of the first half of the total channel length and a second end at the end of the second half of the total channel length, wherein a flow cross-section of the second end is between at least 50% less and up to and including 100% less than an average flow cross-section within the first half and/or the second half of the total channel length.

12. The separator plate according to claim 11,
wherein the first end is open and has a flow cross-section that is at least as large as the average flow cross-section within the first half and/or the second half of the total channel length.

13. The separator plate according to claim 1,
wherein the openings of a respective internal channel have different cross-sectional sizes and/or cross-sectional shapes and/or are otherwise formed differently from one another.

14. The separator plate according to claim 1,
wherein in a region of at least one of the openings of a respective internal channel, a flow cross-section of the internal channel is reduced, at least in sections.

15. The separator plate according to claim 1,
wherein at least one of the openings of a respective internal channel is arranged to define a fluid flow in a direction leading away from the first outer side.

16. The separator plate according to claim 4, wherein the first dimension is at least two times the second dimension.

17. The separator plate according to claim 10, wherein the number of openings per internal channel within the second half is at least three.
